(19) United States
(12) Patent Application Publication
(10) Pub. No.: US 2019/0063433 A1
(43) Pub. Date: Feb. 28, 2019

(54) SCROLL PUMP TIP SEALING

(71) Applicant: Edwards Limited, Burgess Hill,West Sussex (GB)

(72) Inventor: Peter Charles Lamb, Burgess Hill, Sussex (GB)

(21) Appl. No.: 16/079,925

(22) PCT Filed: Feb. 22, 2017
(86) PCT No.: PCT/GB2017/050445

§ 371 Date: Aug. 24, 2018

(30) Foreign Application Priority Data
Feb. 26, 2016 (GB) 1603332.6

(51) Int. Cl. F04C 18/02; F04C 27/00

(52) U.S. Cl. CPC F04C 18/0284; F04C 27/005; F04C 2230/20; F05B 2280/6012; F05B 2230/20; F05B 2240/57; F05B 2280/10; F04C 2240/20

(57) ABSTRACT

A scroll pump tip seal to be fitted to a tip face of a scroll wall of a first scroll of a scroll pump to seal between said tip face and a base plate of a second scroll of the scroll pump. The tip seal is made of metal and has at least one internally disposed void. The metal tip seal may be made of a foamed metal defining a plurality of internally disposed voids.

### CROSS-REFERENCE OF RELATED APPLICATION

This application is a Section 371 National Stage Application of International Application No. PCT/GB2017/050445, filed Feb. 22, 2017, which is incorporated by reference in its entirety and published as WO 201.7/144869 AL on Aug. 31, 2017 and which claims priority of British Application No. 1603332.6, filed Feb. 26, 2016.

### FIELD

The invention relates to scroll pump tip sealing.

### BACKGROUND

Known scroll compressors, or pumps, comprise a fixed scroll, an orbiting scroll and a drive mechanism for the orbiting scroll. The drive mechanism is configured to cause the orbiting scroll to orbit relative to the fixed scroll to cause pumping of a fluid. between a pump inlet and a pump outlet. The fixed and orbiting scrolls each comprise an upstanding scroll wall extending from a generally circular base plate. Each scroll wall has an end, or tip, face disposed remote from and extending generally perpendicular to the respective base plate. The orbiting scroll wall is configured to mesh with the fixed scroll wall during orbiting of the orbiting scroll so that the relative orbital motion of the scrolls causes successive volumes of gas to be enclosed in pockets defined between the scroll walls and pumped from the inlet to the outlet.

A scroll pump may be a dry pump in which the scrolls are not lubricated so the internal working clearances are not sealed with a fluid such as oil. In this case, to prevent back leakage, the tip of each scroll wall is provided with a tip seal to seal against the base plate of the other scroll. The tip seals are located in channels defined in the tips of the scroll walls and are typically made of PTFE. There may be a small gap between the base of each channel and the opposing face of the tip seal so that, in use, fluid occupying the gap forces the tip seal towards and against the base plate of the other scroll. The tip seals close the gap between the scrolls caused by manufacturing and operating tolerances and reduce the leakage to an acceptable level.

Typically, a tip seal is narrower than its channel so that there is a radial clearance between the tip seal and the opposed sidewalls of the channel. During relative orbiting motion of the scrolls, the tip seal is urged against one sidewall for part of its motion and against the other sidewall for another part of its motion. As the tip seal moves back and forth between these positions, leakage is increased because there is a leakage path formed from one side of the seal to the other side of the seal. Known tip seals typically have an aspect ratio of height to radial width which is 1:1. That is, the radial width of the tip seal is equal to the height of the tip seal so that the tip seal has a square cross-section. Accordingly, the tip seal is relatively stiff in the radial, or widthways, direction. When the tip seal moves radially between the sidewalls of the tip seal channel, this relative stiffness slows the movement of the tip seal, thereby increasing leakage.

For some vacuum applications, such as those involving exposure to radioactivity, it is advantageous, or may even be essential, to use an oil free scroll pump. However, where there is to be exposure to radioactivity, it is not possible to use PTFE as the tip seal material.

The discussion above is merely provided for general background information and is not intended to be used as an aid in determining the scope of the claimed subject matter. The claimed subject matter is not limited to implementations that solve any or all disadvantages noted in the background.

### SUMMARY

The invention provides a scroll pump as specified in claim 1.

The invention also includes a scroll pump tip seal as specified in claim 14.

The invention also includes a method of providing a tip seal n a scroll pump as specified in claim 27.

The Summary is provided to introduce a selection of concepts in a simplified form that are further described in the Detail Description. This summary is not intended to identify key features or essential features of the claimed subject matter, nor is it intended to be used as an aid in determining the scope of the claimed subject matter.

### BRIEF DESCRIPTION OF THE DRAWINGS

In the following disclosure, which is given by way of example only, reference will be made to the drawings, in which:

FIG. 1 is a schematic representation of a scroll pump;

FIG. 2 is a schematic plan view of the fixed scroll showing a first example of a tip sealing arrangement;

FIG. 3 is a cross section on line in FIG. 2;

FIG. 4 is an enlargement of the central region of the fixed scroll shown in FIG. 2;

FIG. 5 is a view corresponding to FIG. 4 showing a second example of a tip sealing arrangement;

FIG. 6 is a view corresponding to FIG. 4 showing a third example of a tip sealing arrangement;

FIG. 7 is a view corresponding to FIG. 4 showing a fourth example of a tip sealing arrangement;

FIG. 8 is a view corresponding to FIG. 4 showing a fifth example of a tip sealing arrangement;

FIG. 9 is a view corresponding to FIG. 4 showing a sixth example of a tip sealing arrangement;

FIG. 10 is a schematic perspective view of another metal tip seal;

FIG. 11 is a partial cross section on line XI-XI in FIG. 10; and

FIG. 12 is a side elevation of two metal seal segments for a metal tip seal.

### DETAILED DESCRIPTION

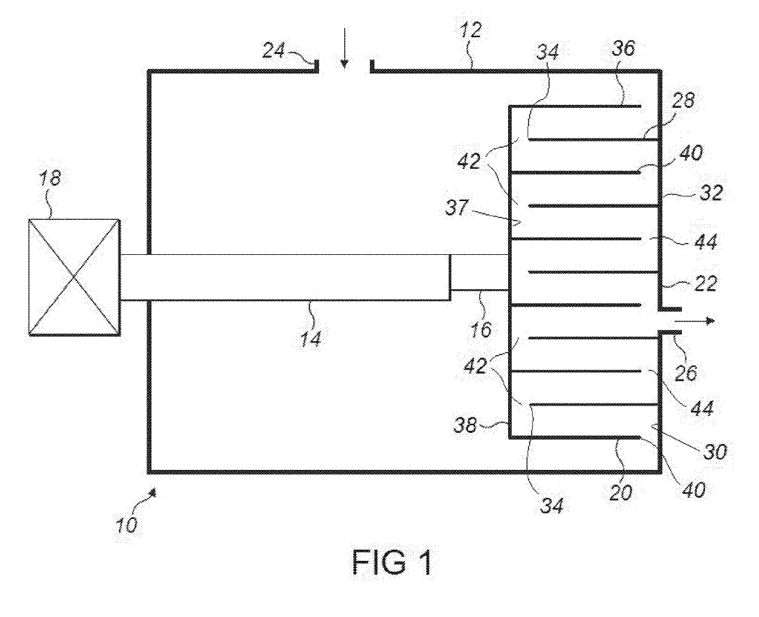

Referring to FIGS. 1 to 4, a scroll pump 10 comprises a pump housing 12 and a scroll driver that in this example comprises a drive shaft 14 having an eccentric shaft portion 16. The scroll driver is driven by a motor 18 that is connected with the drive shaft 14. The eccentric shaft portion 16 is connected with an orbiting scroll 20 so that rotation of the drive shaft imparts an orbiting motion to the orbiting scroll relative to a fixed scroll 22 for pumping fluid along a fluid flow path between a pump inlet 24 and pump outlet 26.

The fixed scroll 22 comprises a spiralling, or involute, scroll wall 28. The scroll wall 28 extends perpendicularly from a major surface 30 of a generally circular base plate 32 and has an end, or tip, face 34 that is spaced from the major surface 30. The tip face 30 may be generally parallel to the major surface 30. The orbiting scroll 20 comprises a spiralling, or involute, scroll wall 36. The scroll wall 36 extends perpendicularly from a major surface 37 of a generally circular base plate 38 and has an end, or tip, face 40 that is spaced from the major surface 37. The tip face 40 may be generally parallel to the major surface 37. The orbiting scroll wall 36 co-operates, or meshes, with the fixed scroll wall 28 during orbiting movement of the orbiting scroll 20. Relative orbital movement of the scrolls 20, 22 causes successive volumes of gas to be trapped in pockets defined between the scrolls and pumped from the inlet 24 to the outlet 26.

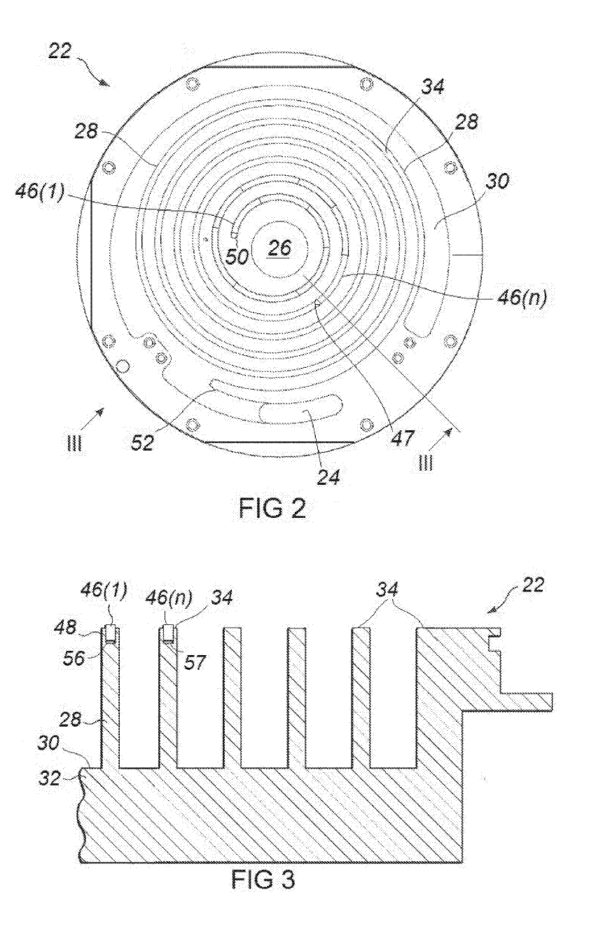

The scroll pump 10 may be a dry pump in which the scrolls 20, 22 are not lubricated so that there is no lubricant present to seal the working clearances between the scrolls. In order to prevent, or at least reduce, hack leakage via respective gaps 42, 44 between the tip faces 34, 40 of the scroll walls 28, 36 and the opposed major surfaces 30, 37 of the base plates 32, 38, respective tip sealing arrangements are provided to close the gaps 42, 44. The tip sealing arrangement for the fixed scroll 22 can be seen in FIGS. 2 to 4 and will be described in detail below. Although not shown in FIGS. 1 to 4, the tip sealing arrangement for the orbiting scroll 20 may be the same as, or similar to, the tip sealing arrangement of the fixed scroll 22.

Referring to FIGS. 2 to 4, the tip sealing arrangement for the fixed scroll 22 comprises a segmented metal tip seal 46(1) to 46(n) located in a channel 48 defined in the tip face 34 of the scroll wall 28. In some examples, the channel 48 may extend from the radially innermost end 50 of the scroll wall 28 to the radially outermost end 52 of the scroll wall. However, in the example illustrated by FIGS. 2 to 4, the channel 48 extends from the radially innermost end 50 of the scroll wall 28 to a position 47 intermediate the radially innermost and radially outermost ends 50, 52. From the end of the channel 48 disposed at the position 47 to the radially outermost end 52 of the scroll wall 28, the tip sealing arrangement may comprise the tip face 34 of the scroll wall without a tip seal. In examples in which a portion of the tip face 34 without a tip seal forms a part of the tip sealing arrangement, the tip face may be provided with one or more depressions defining pockets, recesses, grooves or serrations in the tip face for resisting leakage of fluid between the tip face and the opposed major surface 37 of the base plate 38. In examples in which a portion of the tip face 34 without a tip seal forms a part of the tip sealing arrangement, the segmented metal tip seal 46(1) to 46(n) is provided at the inner end of the scroll wall 28 and a tip seal omitted at the outer end of the scroll wall so that there is no tip seal in areas where the pressure of the pumped fluid will be relatively lower and a tip seal is present where the pressure will be relatively higher.

Referring to FIG. 3, there is a small gap 56 between the base 57 of the channel 48 and the facing side of the segmented metal tip seal 46(1) to 46(n) so that, in use, fluid occupying the gap may force the segmented metal tip seal towards the opposing major surface 37 of the base plate 38 of the orbiting scroll 20. Accordingly, the segmented metal tip seal 46(1) to 46(n) may be supported on a cushion of fluid which serves to urge the seal into sealing engagement with the major surface 37 of the base plate 38. Additionally, and although not shown in FIG. 3, there may be a radial clearance between the segmented metal tip seal 46(1) to 46(n) and the opposed sidewalls of the channel 48. During relative orbiting motion of the scrolls 20, 22, the segmented metal tip seal 46(1) to 46(n) is urged against one sidewall for part of its motion and against the other sidewall for another part of its motion.

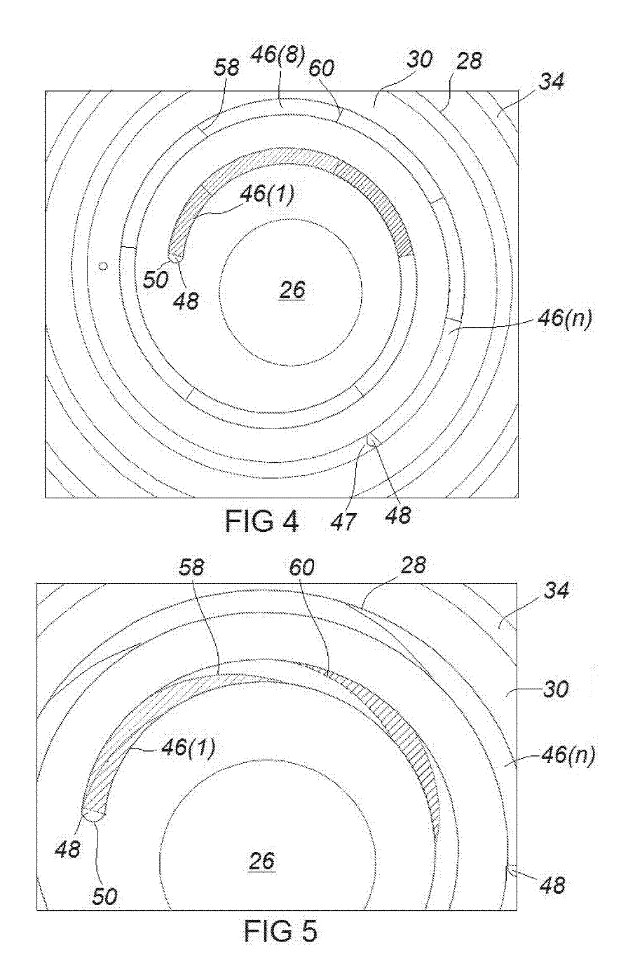

As best seen in FIG. 4, the segmented metal tip seal comprises a plurality of seal segments 46(1) to 46(n) disposed contiguously end to end in the channel 48. The metal seal segments 46(1) to 46(n) are elongate bodies that have a first end 58 and a second end 60 disposed generally opposite the first end and comprise at least one internally disposed void. In cross-section the seal segments 46(1) to 46(n) may be symmetric with respect to a centreline that extends between the first and second ends 58, 60 and may be at least substantially rectangular in cross section. The metal tip seal segments 46(1) to 46(n) may be curved in the lengthways direction of the elongate bodies. In this example the first and second ends 58, 60 each comprise a planar, or flat, end face. Although not essential, in the illustrated example the end faces are upright such that in use they extend at least substantially perpendicular to the base 57 of the channel 48. The first ends 58 of all but metal seal segment 46(1) are disposed in abutting face to face relationship with the respective opposed second ends 60 of the adjacent metal seal segment so that the metal seal segments 46(1) to 46(n) effectively define a substantially continuous metal tip seal having a length corresponding substantially to the sum of the respective lengths of the metal seal segments 46(1) to 46(n).

FIG. 5 is a view generally corresponding to FIG. 4 showing a second example of a metal tip seal comprising a plurality of metal seal segments 46(1) to 46(n) disposed contiguously end to end in the channel 48. The metal seal segments 46(1) to 46(n) are elongate bodies that have a first end 58 and a second end 60 disposed generally opposite the first end and comprise at least one internally disposed void. In this example, all of the metal seal segments 46(1) to 46(n), except the metal seal segments 46(1) and 46(n), have respective first and second ends 58, 60 that comprise inclined end faces. The first end 58 of the first metal seal segment 46(1) and the second end 60 of the metal seal segment 46(n) may comprise an end face, for example an upright planar end face, configured to allow them to be fitted close to the respective ends of the channel 48. The first ends 58 of all but the metal seal segment 46(1) are disposed in abutting face to face overlapping relation with the respective opposed second ends 60 of the adjacent segments so that the segments effectively define a continuous metal tip seal.

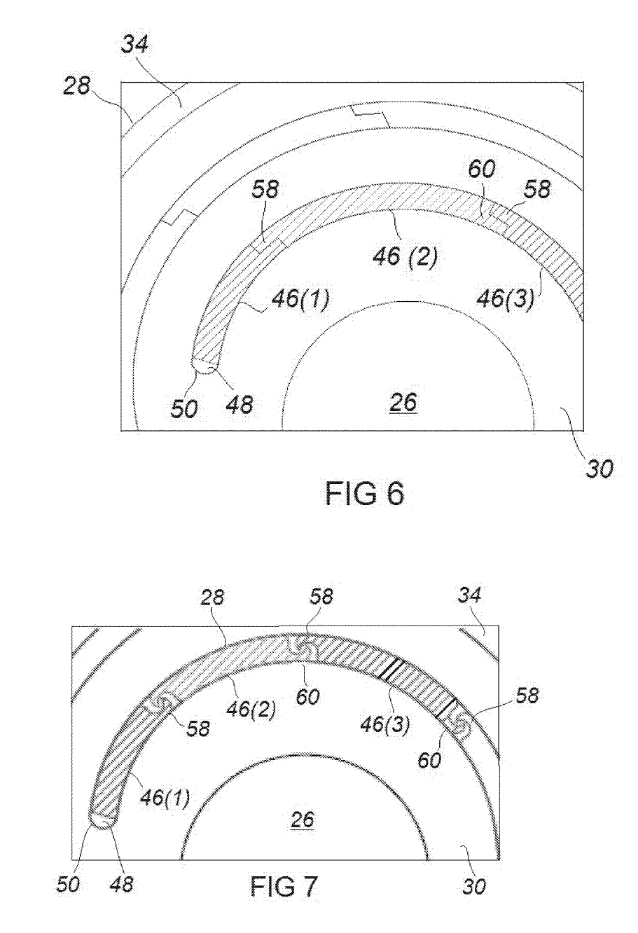

FIG. 6 is a view generally corresponding to FIG. 4 showing a third example of a metal tip seal comprising a plurality of metal seal segments 46(1), 46(2), 46(3) to 46(n) (segment 46(n) is not shown in FIG. 6) disposed contiguously end to end in the channel 48. The metal seal segments 46(1) to 46(n) are elongate bodies that have a first end 58 and a second end 60 disposed generally opposite to the first end and comprise at least one internally disposed void. In this example, all of the metal seal segments 46(1) to 46(n), except the metal seal segments 46(1) and 46(n), have first and second ends 58, 60 comprising respective end faces that are notched to define mating step formations. The first end 58 of the first metal seal segment 46(1) and the second end 60 of the metal seal segment 46(n) may comprise an end face, for example an upright planar end face, configured to allow them to be fitted close to the respective ends of the channel 48. The first ends 58 of all but the first metal seal segment 46(1) are disposed in abutting overlapping relationship with the respective opposed second ends 60 of the adjacent segment. Accordingly, the stepped formation at the first end 58 of the metal seal segment 46(2) overlaps the stepped formation at the second end 60 of the metal seal segment 46(1) and the stepped formation at the first end 58 of the metal seal segment 46(3) overlaps the stepped formation at the second end 60 of the metal seal segment 46(2) so that the metal seal segments 46(1) to 46(n) are arranged to form a substantially continuous metal tip seal. Thus, the configuration of the end faces is such that when brought face to face they are in a side-by-side, non-overlying, overlapping relationship.

Providing metal seal segments that are assembled in overlapping relationship as illustrated by way of example in FIGS. 5 and 6 allows the provision of a larger surface contact area, or interface, between adjacent segments than is obtained with the simple abutting relationship illustrated by the example shown in FIG. 4. The increased surface contact area between adjacent metal seal segments may reduce the potential for leakage between the metal seal segments. The overlap between adjacent segments may also accommodate some thermal expansion while maintaining sufficient sealing between the two scrolls 20, 22.

FIG. 7 is a view generally corresponding to FIG. 4 showing a fourth example of a metal tip seal comprising a plurality of metal seal segments 46(1), 46(2), 46(3) to 46(n) (segment 46(n) is not shown in FIG. 7) disposed contiguously end to end in the channel 48. The metal seal segments 46(1) to 46(n) are elongate bodies that have a first end 58 and a second end 60 disposed generally opposite to the first end and comprise at least one internally disposed void. In this example, all of the metal seal segments 46(1), 46(2), 46(3) to 46(n), except the metal seal segments 46(1) and 46(n), have first ends 58 and second ends 60 that comprise respective interengagable end formations that allow adjacent metal seal segments to be linked in a hinged, or articulated, end to end relationship to form a substantially continuous metal tip seal. The first end 58 of the first metal seal segment 46(1) and the second end 60 of the metal seal segment 46(n) may comprise an end face, for example an upright planar end face, configured to allow them to be fitted close to the respective ends of the channel 48. The connections made by the end formations are such that individual metal seal segments 46(1) to 46(n) cannot separate by relative movement in the lengthways direction of the tip seal. In the illustrated example, the end formations take the form of hooks or undercuts. Forming hinged, or hinge-like, connections between adjacent metal seal segments 46(1) to 46(n) may provide a tip seal with enhanced flexibility, thereby facilitating transverse, or lateral, movement of the metal tip seal between the sidewalls of the channel 48 in response to the orbiting motion of the orbiting scroll 20 and so, potentially, reducing leakage below the tip seal.

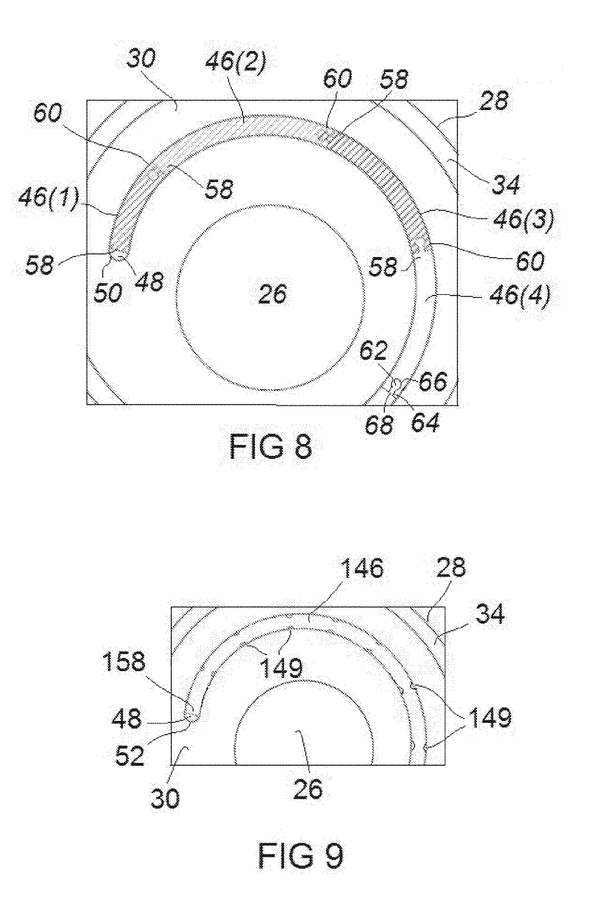

FIG. 8 is a view generally corresponding to FIG. 4 showing a fifth example of a metal tip seal comprising a plurality of metal seal segments 46(1), 46(2), 46(3) to 46(n) (segment 46(n) is not shown in FIG. 8) disposed contiguously end to end in the channel 48. The metal seal segments 46(1) to 46(n) are elongate bodies that have a first end 58 and a second end 60 disposed generally opposite to the first end and comprise at least one internally disposed void. In this example, all of the metal seal segments 46(1), 46(2), 46(3), 46(4) to 46(n), except the seal segments 46(1) and 46(n) have first ends 58 and second ends 60 that comprise respective interengagable end formations that allow adjacent seal segments to be linked in a contiguous end to end relationship to form a substantially continuous metal tip seal. The first end 58 of the first metal seal segment 46(1) and the second end 60 of the metal seal segment 46(n) may comprise an end face, for example an upright planar end face, configured to allow them to be fitted close to the respective ends of the channel 48. The configuration of the end formations is such that individual metal seal segments 46(1) to 46(n) cannot separate by relative movement in the lengthways direction of the metal tip seal.

In this example, the interengagable end formations comprise projections at the first ends 58 that are insertable into mating recesses provided at the second ends 60. The projections may comprise a circular section leading end portion 62 connected with the main body of the metal seal segment 46(2) to 46(n) by a neck portion 64 and the recesses may comprise a circular section inner end portion 66 and a narrower channel 68 extending from the inner end portion to the end of the respective segment. The end formations may be configured such that they interengage by a relative movement in a direction transverse to the lengthways direction of the metal seal segments 46(1) to 46(n). In the illustrated example the end formations at the first ends 58 are insertable into the end formations at the second ends 60 by a relative movement that is at least substantially perpendicular to the longitudinal axes of the metal seal segments 46(1) to 46(n). The end formations may be configured to provide a press, or light interference, fit.

Providing the seal segments with intengagable mating end formations that are a close fit with one another as illustrated by FIG. 8 allows the possibility of forming a positive connection between adjacent metal seal segments so that once assembled the metal seal segments may closely replicate a one-piece metal tip seal. The end formations may for example be configured such that no relative movement in the lengthways direction of the metal tip seal is allowed. Alternatively, or additionally, the end formations may be configured such that no relative lateral movement of the metal seal segments 46(1) to 46(n) is allowed.

In some examples, making the metal tip seal as a segmented tip seal comprising a plurality of discrete metal seal segments that are fitted contiguously end to end in a channel defined in the tip of a scroll wall provides a degree of transverse, or lateral, flexibility that may not be obtainable in a one-piece metal tip seal. Furthermore, it may make manufacture simpler and be less wasteful of the bulk material.

FIG. 9 is a view generally corresponding to FIG. 4 showing a sixth example of a metal tip seal 146. The metal tip seal 146 is a one-piece metal tip seal and defines at least one internally disposed void. The metal tip seal 146 may have a generally rectangular cross section and has a first end 158 and a second end (not shown in FIG. 9). The first end 158 is disposed at the end of the channel 148 that is adjacent the radially innermost end 150 of the scroll wall 28. With reference to FIG. 2, the second end may be disposed adjacent the radially outermost end 52 of the scroll wall 28 or at a position intermediate the two ends such as, for example, the location 47.

The metal tip seal 146 is provided with recesses, or notches, 149 in its sides. The recesses 149 may be disposed at regularly spaced apart intervals along the entire length of the metal tip seal 146 or over just a part of that length. In the illustrated example, there are recesses 149 provided in both sides of the metal tip seal 146. Where recesses 149 are provided in both sides of the metal tip seal 146 they may be disposed in a generally opposed spaced apart relationship as shown in FIG. 9 or staggered. The recesses 149 may be arcuate in cross section and extend over a part, or the full, height of the metal tip seal 146. The recesses 149 may increase the transverse, or lateral, flexibility of the metal tip seal 146 thereby facilitating movement of the metal tip seal between the opposite side walls of the channel 48 orbiting of the scrolls. Recesses 149 may also reduce the mass of the metal tip seal.

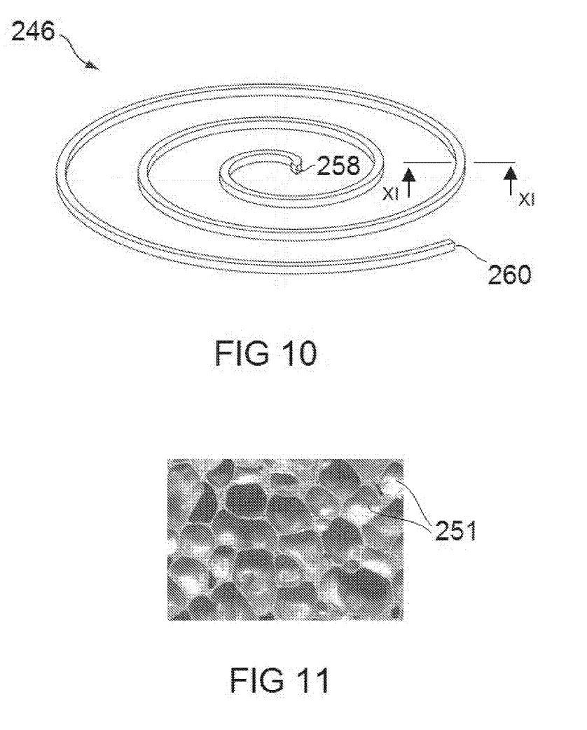

FIG. 10 is a perspective view of another metal tip seal 246 comprising an elongate body that defines at least one internally disposed void. The metal tip seal 246 may have a generally rectangular cross-section and has a first end 258 and a second end 260. Referring to FIG. 2, the length of the metal tip seal 246 may be such that when fitted to a tip face 34, 40 of the scroll pump 10 the first end 258 is disposed adjacent the radially innermost end 250 of the scroll wall 28, 36 and the second end 260 is disposed adjacent the radially outermost end 252 of the respective scroll wall. Alternatively, the metal tip seal 246 may be relatively shorter so that with the first end 258 disposed adjacent the radially innermost end 250 of a scroll wall, the second end 260 is disposed intermediate the radially innermost and outermost ends 250, 252 as illustrated, for example, by FIG. 2.

Referring to FIG. 11, the metal tip seals 146, 246 may be made of a metal foam defining a plurality of internally disposed voids 251. The metal foam may be a closed cell metal foam as shown in FIG. 11. It will be understood that although FIGS. 9, 10 and 11 illustrate a one-piece metal tip seal 246 made of a foamed metal, the use of a foamed metal is not limited to a one-piece metal tip seal and that the metal seal segments of a segmented metal tip seal may similarly be made of a foamed metal.

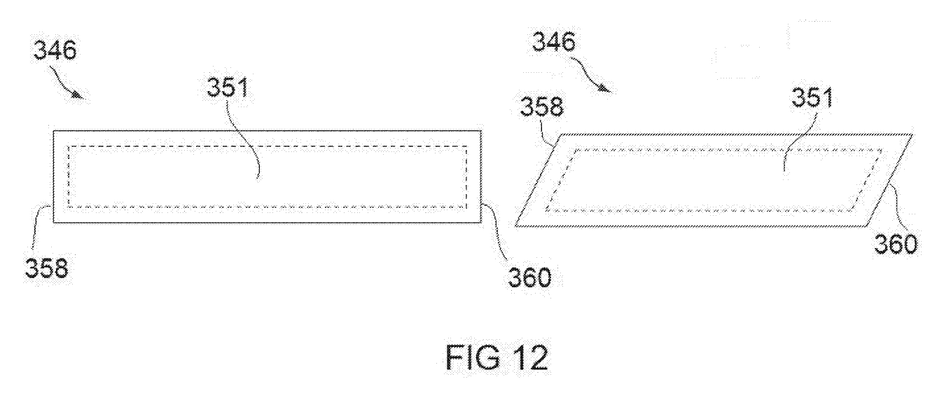

In other examples, a metal tip seal, or metal tip seal segment, may be made from a length of a hollow member, for example a tube, with its ends closed, by for example, suitable crimping or plugging. FIG. 12 shows two metal seal segments 346 that each comprise a hollow member. The first end 358 and second end 360 of each hollow member have been closed by crimping, another deformation process or plugging to define an internally disposed void 351.

A metal tip seal may be made of bronze, which has the advantage that bronze is a material approved for nuclear applications. Using bronze as the segmented tip seal material may also he desirable as bronze has self-lubricating, non-galling, properties, which may be advantageous since the tip seal will be in sliding contact with the opposite scroll. Other metals showing good non-galling properties that may be suitable for producing a segmented tip seal, perhaps in an alloy containing the metal, include cobalt, copper, gold, iridium, nickel, palladium, platinum, rhodium and silver.

As previously described, the metal tip seal may be pressed against an opposed major surface of a scroll base plate by fluid disposed between the base of the channel in which the tip seal is housed and the opposing face of the tip seal. The fluid pressure across the tip seal will vary between a relatively lower pressure adjacent the pump inlet and a relatively higher pressure adjacent the pump outlet. Providing one or more voids within the metal seal tip seal reduces the overall density of the tip seal. This may be advantageous as otherwise the fluid pressure may be insufficient to press the metal tip seal against the opposed scroll base plate, at least at locations at which there is a relatively lower pressure acting across the tip seal. For example, the overall density of a metal tip seal may be reduced by making the tip seal from a foamed metal, which will have a considerably lower density than a solid metal tip seal made of the same metal. By way of example, a solid bronze tip seal may have a density of 8.8 g/cm³ and by using a closed cell foamed bronze tip seal instead, the density may be reduced to 3 to 4 g/cm³. A segmented tip seal may comprise one or more seal segments having a relatively lower density disposed towards the end of the tip seal disposed closest to the pump inlet and one or more seal segments having a relatively higher density disposed towards the end of the tip seal disposed closest to the pump outlet. Thus, one or more hollow or foamed metal seal segments may be provided towards the end of the tip seal disposed closest to the pump inlet and one or more solid metal seal segments may be provided towards the end of the tip seal disposed closest to the pump outlet.

As previously described, the metal tip seal may be provided only at the radially innermost end of the scroll walls and the portion of the tip face without a metal tip seal may form the remainder of the tip sealing arrangement. In other examples, a metal tip seal may be provided along at least substantially the entire length of the scroll wall. The metal seal segments may all have substantially the same length. Alternatively, different length metal seal segments may be provided. In examples in which different length seal segments are used, relatively short metal seal segments may be used at the radially innermost end of the scroll walls where the curvature of the scroll wall is greatest and relatively longer segments may be used as the curvature of the scroll wall decreases. In some examples, a single metal seal segment may be used for one or more of the radially outer turns of the scroll wall, while a plurality of seal segments is used for just one of the radially inner turns of the scroll wall. It may be advantageous to use relatively shorter length metal seal segments in at least some examples as using relatively longer length metal seal segments may require the provision of a larger number of metal seal segments with different curvature to take account of the changing curvature of the scroll wall. However, using relatively longer metal seal segments may be beneficial in reducing assembly times and reducing the number of potential leakage paths through the tip seal.

In some examples the metal seal segments may have a length in the range 20 to 100 mm, while in other examples the metal seal segments may have a length in the range 20 to 60 mm. In some examples, at least one of the metal seal segments may have a curved length in the range of 1 to 5% of the curved length of the tip face between the radially innermost and radially outermost ends 50, 52 of the scroll wall In other examples, there may be at least one metal seal segment having a curved length in the range of 1 to 2% of the curved length of the tip face. In still other examples, at least one of the metal seal segments may have a curved length of about 1.5% of the curved length of the curved length of the tip face.

The greatest wear to a scroll pump tip seals should occur at the ends of the scroll walls disposed adjacent the pump outlet 26 where the operating pressures should be highest. Providing a metal tip seal made of metal tip seal segments gives rise to the possibility of replacing only those seal segments that are worn sufficiently to require replacement and leaving the remaining metal seal segments in situ for continued use. This may be both more cost efficient in terms of materials usage and is also more environmentally friendly. Furthermore, having relatively short lengths of new tip seal to wear in following a maintenance operation may be beneficial since the volume of dust produced during wearing in of the tip seal should be reduced.

Although elements have been shown or described as separate embodiments above, portions of each embodiment may be combined with all or part of other embodiments described above.

Although the subject matter has been described in language specific to structural features and/or methodological acts, it is to be understood that the subject matter defined in the appended claims is not necessarily limited to the specific features or acts described above. Rather, the specific features and acts described above are described as example forms of implementing the claims.

1. A scroll pump comprising:
an orbiting scroll;
a fixed scroll; and
a driver configured to impart an orbiting motion to the orbiting scroll relative to the fixed scroll;
wherein said orbiting scroll comprises an orbiting scroll base plate and an orbiting scroll wall extending from said orbiting scroll base plate towards said fixed scroll and said fixed scroll comprises a fixed scroll base plate and a fixed scroll wall extending from said fixed scroll base plate towards said orbiting scroll,
said orbiting scroll wall has a tip face that faces said fixed scroll base plate and said fixed scroll wall has a tip face that faces said orbiting scroll base plate,
said tip face of the orbiting scroll wall is provided with a first tip seal arrangement for sealing between the orbiting scroll wall and the fixed scroll base plate and said tip face of
the fixed scroll wall is provided with a second tip seal arrangement for sealing between the fixed scroll wall and the orbiting scroll plate,
at least one of said first and second tip seal arrangements comprises a metal tip seal disposed on the respective tip face, and
said metal tip seal comprises at least one internally disposed void.

2. The scroll pump as claimed in claim 1, wherein at least in part said metal tip seal comprises a metal foam defining a plurality of said voids.

3. The scroll pump as claimed in claim 1, wherein said metal tip seal comprises a hollow metal member.

4. The scroll pump as claimed in claim 1, wherein said metal tip seal comprises a plurality of metal seal segments disposed contiguously end to end.

5. The scroll pump as claimed in claim 4, wherein said metal seal segments each comprise planar end faces and are arranged such that respective opposed said end faces of adjacent said metal seal segments are in abutting relationship.

6. The scroll pump as claimed in claim 4, wherein said metal seal segments each comprise at least one end face configured such that respective opposed said end faces of adjacent said metal seal segments are disposed in overlapping relationship.

7. The scroll pump as claimed in claim 6, wherein said overlapping end faces are inclined and are disposed in overlying relationship.

8. The scroll pump as claimed in claim 4, wherein said metal seal segments each comprise an end provided with an end formation mated with an end formation of an adjacent said metal seal segment.

9. The scroll pump as claimed in claim 8, wherein said end formations are configured to provide hinged connections between said metal seal segments.

10. The scroll pump as claimed in claim 8, wherein said end formations comprise projections and mating recesses.

11. The scroll pump as claimed in claim 4, wherein said plurality of metal seal segments comprises at least one seal segment having a length in the range:
i) 20 to 100 mm; or
ii) 20 to 60 mm.

12. The scroll pump as claimed in claim 11, wherein each said metal seal segment has a length in at least one of said ranges.

13. The scroll pump as claimed in claim 4, wherein said plurality of metal seal segments comprises at least one first seal segment that has a first density and at least one second seal segment that has a second density, said second density being higher than said first density.

14. A scroll pump tip seal to be fitted to a tip face of a scroll wall of a first scroll of a scroll pump to seal between said tip face and a base plate of a second scroll of said scroll pump, said tip seal being made of metal and comprising at least one internally disposed void.

15. The scroll pump tip seal as claimed in claim 14, at least partially made of a metal foam that defines a plurality of said voids.

16. The scroll pump tip seal as claimed in claim 14, wherein said metal tip seal comprises a hollow metal member.

17. The scroll pump tip seal as claimed in claim 14, wherein said metal tip seal comprises a plurality of metal seal segments to be fitted contiguously end to end to said tip face.

18. The scroll pump tip seal as claimed in claim 17, wherein said metal seal segments each comprise planar end faces configured to be disposed in abutting face to face relationship when said metal seal segments are disposed in said contiguous end to end relationship.

19. The scroll pump tip seal as claimed in claim 17, wherein said metal seal segments each comprise at least one end face configured such that respective opposing said end faces of adjacent said metal seal segments are disposed in overlapping relationship when said metal seal segments are disposed in said contiguous end to end relationship.

20. The scroll pump tip seal as claimed in claim 19, wherein said end faces are configured such that said overlapping end faces are in overlying relationship.

21. The scroll pump tip seal as claimed in claim 17, wherein said metal seal segments each comprise at least one end provided with an end formation configured to mate with an end formation of an adjacent said metal seal segment when said metal seal segments are disposed in said contiguous end to end relationship.

22. The scroll pump tip seal as claimed in claim 21, wherein said end formations are configured to provide a hinged connection between said adjacent metal seal segments.

23. The scroll pump tip seal as claimed in claim 22, wherein said end formations comprise projections and mating recesses.

24. The scroll pump tip seal as claimed in claim 17, wherein said plurality of metal seal segments comprises at least one metal seal segment having a length in the range:
i) 20 to 100 mm; or
ii) 20 to 60 mm.

25. The scroll pump tip seal as claimed in claim 24, wherein each said metal seal segment has a length in at least one of said ranges.

26. The scroll pump tip seal as claimed in claim 17, wherein said plurality of metal seal segments comprises at least one first seal segment that has a first density and at least one second seal segment that has a second density, said second density being higher than said first density.

27. A method of manufacturing a metal tip seal to seal between a tip face of a scroll wall of a first scroll of a scroll pump and a base plate of a second scroll of said scroll pump, said method comprising providing said metal tip seal with at least one internally disposed void.

28. The method of manufacturing a metal tip seal as claimed in claim 27, comprising forming at least a part of said metal tip seal as a metal foam that defines a plurality of said voids.

29. The method of manufacturing a metal tip seal as claimed in claim 27, wherein at least a part of said metal tip seal comprises a hollow member.

30. The method of manufacturing a metal tip seal as claimed in claim 27, comprising disposing a plurality of metal seal segments contiguously end to end on said tip face to form a continuous said metal tip seal.

31. The method as claimed in claim 30, comprising disposing said plurality of metal seal segments such that respective opposed end faces of adjacent said seal segments are in abutting face to face relationship.

32. The method as claimed in claim 31, comprising disposing said plurality of metal seal segments such that said abutting end faces overlap.

33. The method as claimed in claim 32, further comprising providing each said metal seal segment with at least one inclined end face such that said abutting end faces are in an overlying relationship.

34. The method as claimed in claim 30, further comprising disposing said plurality of metal seal segments such that respective opposed end formations of adjacent said seal segments mate.

35. The method as claimed in claim 34, further comprising configuring said end formations such that respective hinged connections are made between said adjacent metal seal segments.

36. The method as claimed in claim 30, wherein said plurality of metal seal segments comprises at least one first seal segment that has a first density and at least one second seal segment that has a second density, said second density being higher than said first density.

37. The method as claimed in claim 27, wherein said scroll wall has a radially innermost end, a radially outermost end and a length between said ends and metal tip seal extends from said radially innermost end to a position intermediate said ends.
